(19) United States
(12) Patent Application Publication
(10) Pub. No.: US 2004/0122725 A1
(43) Pub. Date: Jun. 24, 2004

(54) System and method for generating a strategic marketing plan for enhancing customer relations

(75) Inventors: Daniel Kyle Womack, Lynchburg, VA (US); Claudia Goff Butler, Forest, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: GE Financial Assurance Holdings, Inc.

(21) Appl. No.: 10/322,647

(22) Filed: Dec. 19, 2002

(51) Int. Cl. G06F 17/60

(52) U.S. Cl. 705/10; 705/1; 705/14

(57) ABSTRACT

An aspect of the present invention relates to a growth strategy and implementation system and method. In particular, the present invention relates to a system and method for generating a strategic marketing plan for growing and/or retaining customers in an industry, which may be realized by conducting behavior examination for one or more customers based on a recency factor, a frequency factor and a monetary factor; segmenting the one or more customers into a segment set based on a score, wherein the score comprises a value associated with the recency factor, the frequency factor and the monetary factor; assessing a customer need through a qualitative assessment and a quantitative assessment; and generating a strategic marketing plan based at least in part on the steps of conducting, segmenting and assessing.

### BACKGROUND OF THE INVENTION

The present invention relates to a growth strategy and implementation system and method. More particularly, the present invention relates to a system and method for generating a strategic marketing plan for growing and/or retaining customers in an industry.

The brokerage business is extremely competitive and includes a plethora of players. Brokerage general agencies coordinate with a plurality of agents, who transact business with clients. Agents may sell various services and products, such as life insurance, auto insurance, home insurance, annuities, mutual funds, stocks and bonds, for example. Oftentimes, agents will coordinate with more than one brokerage general agency. As there are generally a wide range of brokerage general agencies to transact business with, agents may easily and frequently move business around. In addition, brokerage general agencies are primarily distinguished by the products or services sold.

Currently, brokerage general agencies are not well equipped to address agents needs and preferences. Further, all agents are generally seen and treated equally, which is an unrealistic way to manage and grow customers. For example, some agents may be high producers, some agents may produce at moderate levels while others may fail to produce at a competitive or even acceptable level. By treating all agents in the same way, some agents may become dissatisfied. In addition, by failing to understand preferences associated with a common group of agents, resources are wasted.

Therefore, there is a need in the industry to overcome these and other drawbacks.

### BRIEF SUMMARY OF THE INVENTION

Accordingly, an embodiment of the present invention is directed to a system and method for generating a strategic marketing plan for enhancing customer relations in an industry that overcomes these and other drawbacks of present systems and methods.

According to an embodiment of the present invention, a method for implementing a strategic marketing plan for enhancing customer relations for an entity comprises the steps of conducting behavior examination for one or more customers based on a recency factor, a frequency factor and a monetary factor; segmenting the one or more customers into a segment set based on a score, wherein the score comprises a value associated with the recency factor, the frequency factor and the monetary factor; assessing a customer need through a qualitative assessment and a quantitative assessment; and generating a strategic marketing plan based on the steps of conducting, segmenting and assessing.

According to an embodiment of the present invention, a system for implementing a strategic marketing plan for enhancing customer relations for an entity comprises a customer behavior examination module for conducting behavior examination for one or more customers based on a recency factor, a frequency factor and a monetary factor; a segmentation module for segmenting the one or more customers into a segment set based on a score, wherein the score comprises a value associated with the recency factor, the frequency factor and the monetary factor; an assessment input for assessing a customer need through a qualitative assessment and a quantitative assessment; and a strategic marketing plane module for generating a strategic marketing plan based on the steps of conducting, segmenting and assessing.

### BRIEF DESCRIPTION OF THE DRAWINGS

The accompanying drawings, which are incorporated in and constitute a part of this specification, illustrate an embodiment of the invention and, together with the description, serve to explain the principles of the invention.

FIG. 1 is a flowchart illustrating steps in a method for generating a strategic market plan, according to an embodiment of the present invention.

FIG. 2 is a flowchart illustrating a customer behavior examination, according to an embodiment of the present invention.

FIG. 3 is a flowchart illustrating customer segmentation, according to an embodiment of the present invention.

FIG. 4 is a flowchart illustrating needs and values assessment, according to an embodiment of the present invention.

FIG. 5 is a schematic representation of an exemplary strategic market plan, according to an embodiment of the present invention.

FIG. 6 is a schematic representation of a system for generating a strategic market plan, according to an embodiment of the present invention.

### DETAILED DESCRIPTION OF THE INVENTION

Reference will now be made in detail to the present embodiments of the invention, examples of which are illustrated in the accompanying drawings.

An embodiment of the present invention is directed to assessment and growth strategy systems. According to a particular application, an embodiment of the present invention may be used in various industries, such as life insurance, annuities, long term care insurance, employee benefits, health insurance, disability insurance, property and casualty insurance as well as mutual funds and/or other investments. In a particular industry, Brokerage General Agencies (BGAs) may conduct business with customers who may in turn sell or conduct business with various clients. Customers may include agents and/or producers, for example, who sell a service or product, such as life insurance, to clients. Brokerage General Agencies may perform a variety of functions, such as assess customer purchase behavior; assess customer wants and needs; segment customers and outline specific actions to accelerate growth with different segments.

An embodiment of the present invention enables BGAs to move from a primarily intuitive marketing approach to a systematic, empirical approach that leads to growth through business changes and getting the right messages to the right customers at the right time using the right media.

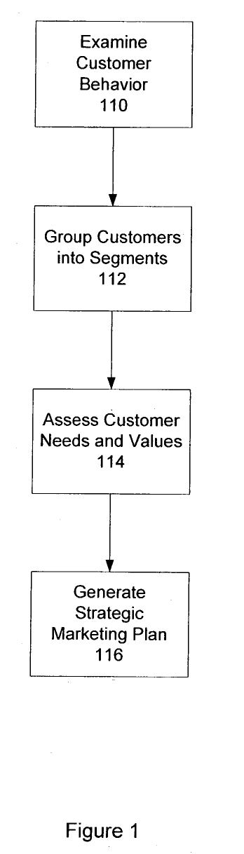

FIG. 1 is a flowchart illustrating steps in a method for generating a strategic market plan(s), according to an embodiment of the present invention. At step 110, customer behavior is examined. At step 112, behavior based segmentation is conducted. In addition, a basic strategy may be assigned to each segment. At step 114, customer needs and values are assessed. At step 116, a strategic marketing plan is generated in response, at least in part, to the above steps.

At step 110, customer behavior examination may involve analyzing one or more customer databases. For example, customer behavior examination may involve implementing a Recency, Frequency, Monetary (RFM) type of analysis on a customer database, such as a BGA's database of producers. This step enables BGAs to analyze customer (e.g., producer) behavior in a systematic way.

At step 112, based on the RFM analysis, customers may be grouped into a plurality of segments. For example, each customer may be segmented into a first segment, a second segment or a third segment. In this example, the first segment represents a group of high producers, the second segment represents a group of core producers and the third segment represents a group of at-risk producers. Other segments may be used for different industries and applications. In addition, a different number of segments may be implemented. A basic strategy may be associated with each segment. For example, for the first segment, a basic strategy may involve retention (e.g., Retain). For the second segment, a basic strategy may involve growth (e.g., Grow). For the third segment, a basic strategy may involve winning back these producers (e.g., Win-Back). Depending on various needs, goals as well as the industry involved, other segments and associated basic strategies may be implemented to address a specific or general need.

At the needs and values assessment step 114, an embodiment of the present invention moves from behavior analysis to attitudinal and needs analysis. Each of the identified segments may be examined to gain an understanding of needs and values associated with working and communicating with an entity (e.g., BGAs). In this exemplary embodiment, two primary tools may be used, each standardized, but leaving some room for customization to a BGA's unique needs. In this example, focus groups and survey methodology may be implemented. Other techniques or tools may be designed and implemented to perform the assessment.

At step 116, one or more executable strategic marketing plans may be generated based at least in part on the data collected above. In an exemplary embodiment, each of the segments may have a customized executable strategic marketing plan. Each plan for each segment may addresses issues such as who to contact; when to contact them as well as what media to use when contacting them, for example. These plans would naturally be unique as the plans will be based on data gathered from a BGA's unique customers. A standard framework, however, may be provided to facilitate the analysis and merging of segment or all assessment data.

An embodiment of the present invention may be designed to help distributors (or other entities) grow their businesses through the execution of one or more strategic marketing plans based on an understanding of customer behavior, needs and values. An embodiment of the present invention may be directed to a customer needs and behavior driven strategic marketing plan illustrating specific actions for growing and/or retaining business with each customer segment.

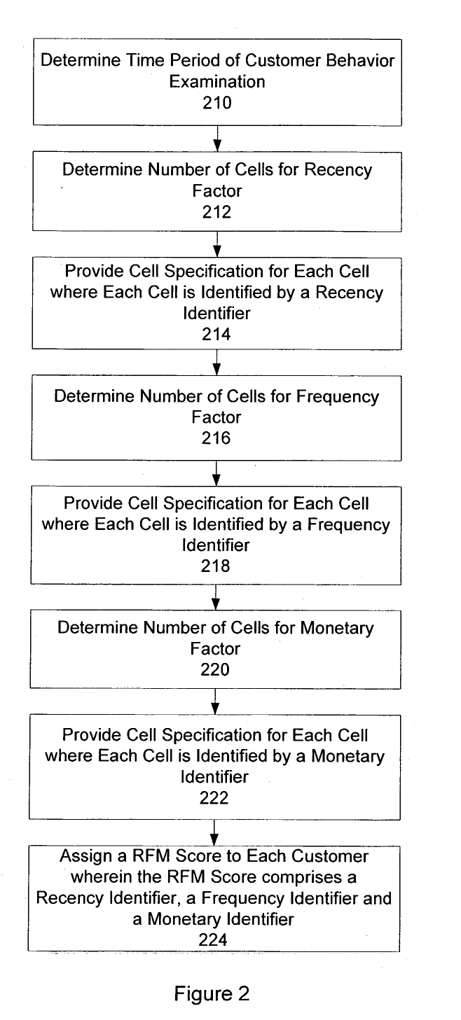

FIG. 2 is a flowchart illustrating customer behavior examination, according to an embodiment of the present invention. An aspect of an embodiment of the present invention may involve assisting providers (or other entities) to examine customer behavior. In particular, providers may systematically examine the purchasing behavior of customers, as detailed below.

Customer behavior examination may be based on a plurality of parameters, which may include a Recency Factor, a Frequency Factor and a Monetary Factor, otherwise known as a Recency, Frequency, Monetary (RFM) Analysis.

The Recency Factor may represent a measure of how recently a given customer has placed business. The Recency Factor may be measured in days, weeks or other time period. The Frequency Factor may represent a measure of the number of transactions placed by a given customer during a time period, e.g., the most recent 12 month period. The Frequency Factor may be measured in units with 1 transaction equal to one unit, for example. The Monetary Factor may represent a dollar measure of business conducted in a time period, e.g., the most recent 12 months. The Monetary Factor may be measured in dollars (e.g., annual premium dollars for insurance business) or other monetary measure.

At step 210, a time period for customer behavior examination may be determined. For example, examination may be performed for a predetermined period of time, such as the most recent 12 months. At step 212, a number of cells for the Recency Factor may be determined. At step 214, cell specifications for each cell may be provided, where each cell is identified by an identifier (e.g., a numerical value). At step 216, a number of cells for the Frequency Factor may be determined. At step 218, cell specifications for each cell may be provided, where each cell is identified by an identifier (e.g., a numerical value). At step 220, a number of cells for the Monetary Factor may be determined. At step 222, cell specifications for each cell may be provided, where each cell is identified by an identifier (e.g., a numerical value). At step 224, a RFM score may be assigned to each customer.

A RFM calculation may be conducted in a manner that creates a set of possible categories into which each customer will fit. For example, customer distributions into RFM cells may include three cells (1, 2, 3) for a Recency Factor; two cells (1, 2) for a Frequency Factor and three cells (1, 2, 3) for a Monetary Factor. Other distributions may be implemented as well. For example, 18 possible categories may be created. Other number of categories may be implemented in accordance with an embodiment of the present invention.

As mentioned above, at step 214 cell specifications for the Recency Factor may be provided. According to an example of an embodiment of the present invention, cell specifications for the Recency Factor may group customers based on a recent transaction. For example, cell 3 may represent customers placing business in most recent 60 days; cell 2 may represent customers with most recent business placed in past 61-180 days; and cell 1 may represent customers with most recent business placed 181 or more days ago. Other cell distributions and specifications may be implemented.

As mentioned above, at step 218 cell specifications for the Frequency Factor may be provided. Cell specifications for the Frequency Factor may group customers based on a frequency percentage. For example, cell 2 may represent customers with a total transaction count in top 40% and cell 1 may represent customers with a total transaction count in bottom 60%. Other cell distributions and specifications may be implemented.

As mentioned above, at step 222 cell specifications for the Monetary Factor may be provided. Cell specifications for the Monetary Factor may group customers based on a total transaction percentage. For example, cell 3 may represent customers with a total transaction dollars in the top 25%; cell 2 may represent customers with a total transaction dollars in the middle 26-70%; and cell 1 may represent customer with a total transaction dollars in the bottom 30%. Other cell distributions and specifications may be implemented.

Each customer may be identified by a RFM score. In this example, a three digit number may indicate customer purchasing behavior where the first digit is a recency value, the second digit is a frequency value and the third digit is a monetary value.

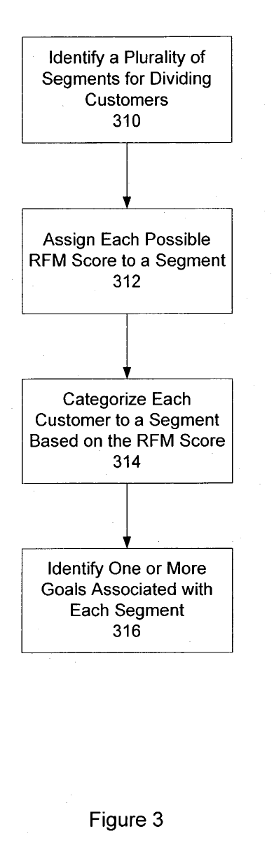

FIG. 3 is a flowchart illustrating customer segmentation, according to an embodiment of the present invention. Using the data generated by the RFM analysis, customers may be divided into a plurality of segments (e.g., three segments), at step 310.

According to an example of an embodiment of the present invention, three exemplary segments may be implemented with one or more goals associated with each segment. Additional segment(s) or less segments may be implemented. In this example, a first segment may represent a most active group of customers generating the most gross dollars. A goal may be to retain their business at least at current levels.

A second segment may represent moderate activity that may be deemed relevant (or critical) to overall business success and risk reduction. The second segment may include many new or newer customers. A goal associated with this segment may be to grow their business.

A third segment may represent customers with declining business or those who conducted only minimal business when new and failed to became established. A goal associated with this segment may involve winning back those who were once substantial players.

At step 312, each possible RFM score may be assigned to a segment as illustrated in Table 1 below. For example, each of the 18 score possibilities may be assigned to one of the segments. The following exemplary table illustrates RFM scores that may be included in each segment. Other assignments may be implemented.

TABLE 1

| First | Second | Third |
|---|---|---|
| 323 | 321 | 123 |
| 313 | 311 | 113 |
| 223 | 322 | 122 |
| 213 | 312 | 121 |
| | 222 | 112 |
| | 212 | 111 |
| | 221 | |
| | 211 | |

In this example, a customer having a RFM score of 323 with a recency factor of three, a frequency factor of two and a monetary factor of three is associated with the first group. At step 314, each customer may be categorized into a segment based on the RFM score. Each segment may be assigned a goal (e.g., a fundamental goal) with more specific goal(s) to be driven by data collected in a research phase of system implementation, at step 316.

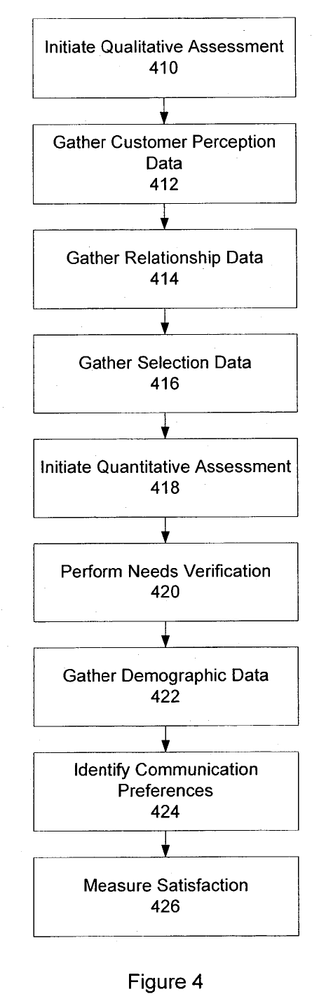

FIG. 4 is a flowchart illustrating needs and values assessment, according to an embodiment of the present invention. According to another embodiment of the present invention, a customer needs and values assessment may be conducted in one or more phases (e.g., two or more phases). For example, the assessment may include at least a qualitative assessment phase and/or a quantitative assessment phase. The qualitative assessment phase may utilize focus groups and/or one-on-one in-depth interviews to gather perceptions, beliefs as well as attitudes. The quantitative assessment phase may involve gathering standard demographic information and/or customizable content for quantifying and verifying information gained in the qualitative assessment phase.

At step 410, for the qualitative assessment phase, opinions, beliefs and/or attitudes of each of the segments (e.g., the three segments) identified through the Behavior Based Segmentation may be assessed. Various methods for qualitative assessment may be implemented, such as focus groups as well as one-on-one interviews, which may be used when assembling groups are not feasible, for example. Other tools or methods for qualitative assessment may be used. At step 412, customer perception data may be gathered. Customer perception data may include how an agent (or customer) perceive BGAs in general and a particular entity. Customer perception data may also include how agents perceive their clients and their business. At step 414, customer relationship data may be gathered. Customer relationship data may include understanding the kind of relationship agents (or customers) would like to have with BGAs in general and with a particular entity. At step 416, selection data may be gathered. Selection data may include ways that BGAs are selected and/or factors that are involved in how BGAs are selected by agents.

Segments may be created based on differences in purchasing behavior. Other parameters and factors may be considered. The qualitative work may be used to help understand what motivates each segment and to assist in identifying possible reasons for differing customer (e.g., purchase) behavior.

The number of groups and number of locations for conducting qualitative assessment may depend in part on the quantity of customers and/or associated geographic data. For example, locations may be chosen based on a geographic dispersion of customer populations. For example, each location may include at least one group of customers from each segment. Exemplary group guidelines may be based on various factors and considerations. For example, locations may be based on geographic spread of customers. In particular, a large, geographically diverse customer base may warrant more locations to address or minimize potential geographic bias. In each geographic location, at least one identified segment (e.g., first, second and third groups) may be placed in each location. Each group may include a preferred number of participants (e.g., 6-8 participants where recruiting 8-10 will generally yield the desired group sizes).

An individual (e.g., someone with experience in this type of research) may moderate the focus groups. The individual may be an “outsider,” with no or limited ties to the company (or an entity that is focus of the assessment). While the specifics may vary for differing industries and/or differing goals, basic content and guidelines may begin with a discussion of the broadest topics, narrowing as necessary while the group progresses. While growth is an ultimate goal, a purpose in the qualitative research may include better understanding what the customers need (from the type of company conducting the research) and how the customers decide where to place their business. The assessment may focus on a combination of the following: what is important to their business; what they need from their suppliers (or other entity); what they are currently getting from their suppliers; what gaps exist between what they are getting and what they need; what their customers need; how they perceive a company (or other entity); areas where the company needs to improve; and/or what the company should do to get more of business. Other factors may be considered as well.

Some factors to consider while analyzing the data may include: what differences exist among the segments; do they have differing needs; do they have different customer bases; do they perceive a company (or other entity) differently; do they differ in their suggestions for growing with the company; do any differences seem to be related to business needs (e.g., personalities, geography, age, and/or gender); the language customers use in describing their businesses, their customers and their relationships with the company and/or other considerations.

At step 418, the quantitative assessment phase may be implemented to confirm that the given needs exist with a broader base of customers and to further solidify differing needs and highlight potentially vital demographic differences among segments. The qualitative assessment phase may involve a questionnaire which may be conducted with a paper-based questionnaire, via a telephone and/or Web-based surveying system. As with the qualitative phase, this phase allows examination of data by each of segments (e.g., first segment, second segment and third segment).

The quantitative tool may include a plurality of components, which may include needs verification/quantification; demographic data; communication preferences/needs; and/or critical attribute satisfaction. Other data may be considered.

At step 420, needs of the customer may be verified. The needs verification/quantification portion of the quantitative tool may be used for verifying and/or quantifying the needs that were identified during the qualitative phase. By nature, this may vary broadly depending on the type of business and the particular customer base. In general, however, the goal may involve asking about the apparently significant needs that were mentioned in the qualitative research. Questions may be structured in a way that identifies the percentage of the customer base that has a given need.

At step 422, demographic data may be gathered. Demographic data may encompass a variety of things, but the critical factors may be identified as the ones that have an impact on a particular business or other need. Generally, the information to be considered may include size of the customers' businesses (which may be measured in a way familiar to an industry); years customers have been in business; products sold (with a particular company and others); percentage of total business coming from each product line; and/or other information. Age, gender and/or other personal information about the principal(s) of the customers' businesses may also be considered pertinent.

At step 424, communication preferences and/or needs may be identified. For communication preferences/needs, a factor in the identified growth opportunities will involve getting the right messages to the right people at the right times. This section of the quantitative tool should ask about communication preferences. These questions may cover media preferences; frequency preferences; and/or content needs and preferences.

At step 426, customer satisfaction may be measured. For critical attribute satisfaction, the qualitative research may identify needs and provide feedback on how an entity is performing. The quantitative research provides an opportunity to assess, on a more predictive scale, how an entity is performing on critical measures. The quantitative assessment serves, in part, to provide projectable substantiation and a level of magnitude for issues uncovered in the qualitative research.

While there are many different ways to measure satisfaction and a multitude of scales have been used, customer satisfaction may be measured by a scale that directs the respondent to compare an entity's performance to that on various attributes to that of the entity's competitors. An exemplary scale may include 1: Best in the Business; 2: Better than Most; 3: Average; 4: Worse than Most and 5: Worst in the Business.

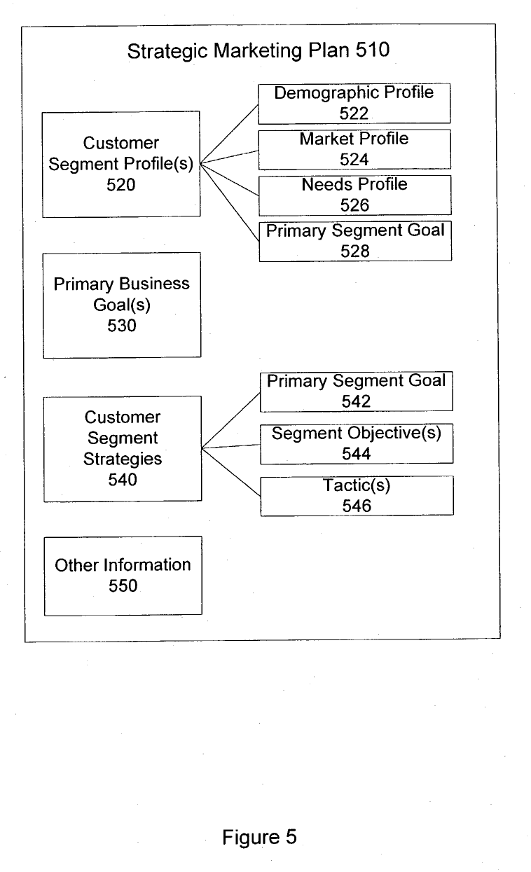

FIG. 5 is an example of a strategic marketing plan, according to an embodiment of the present invention. A strategic marketing plan 510 may be generated by an embodiment of the present invention. The design of the strategic marketing plan may be driven at least in part by the data gathered as discussed above. The strategic marketing plan provides a blueprint for a variety of purposes, such as targeting the right customers at the right time with the right products, services and messages via the right media.

Using the data gathered above to complete the templates on the following pages will provide both a strategic and tactical guide for a variety of customer efforts.

The strategic marketing plan 510 may have a plurality of components, which may include Customer Segment Profile(s) 520, Primary Business Goal(s) 530, and/or Customer Segment Strategies 540. Other information may be provided, as shown by 550. Customer Segment Profile(s) 520 may provide a snapshot of the customer segments (e.g., first segment, second segment, third segment, etc.) and provides a more detailed analysis at the major goals for each segment. Customer Segment Profile(s) 520 may provide Demographic Profile 522, Market Profile 524, Needs Profile 526 and Primary Segment Goal 528. Customer Segment Profile may be viewed for each segment. Primary Business Goal(s) 530 provides a high-level examination of where the business wants to go. Customer Segment Strategies 540 provides an analysis on how to approach each segment in an effort to achieve the primary business goal(s). Here, measurable objectives may be developed to serve as a scorecard and determine actions to ensure enhancements in customer relations, for example. Customer Segment Strategies 540 may include Primary Segment Goal 542, Segment Objective(s) 544 and Tactic(s) 546.

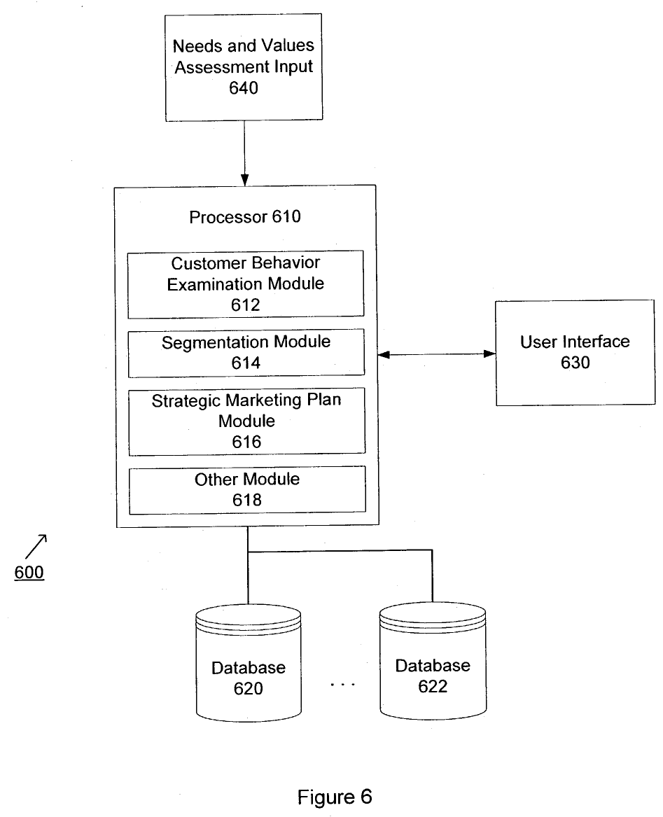

FIG. 6 is a schematic representation of a System 600 for generating a strategic marketing plan according to an embodiment of the present invention. The system may include a Processor 610, one or more databases 620, 622, a Needs and Values Assessment input 640 and a User Interface 630. According to an embodiment of the present invention, a computer-usable and writeable medium having a plurality of computer readable program code stored therein may be provided for practicing the process of the present invention described above. The process and system of the present invention may be implemented within a variety of operating systems, such as Windows ® operating systems, various versions of a Unix-based operating system, or various versions of an AS/400-based operating system. For example, the computer-usable and writeable medium may be comprised of a CD ROM, a floppy disk, a hard disk, or any other computer-usable medium.

According to an embodiment of the present invention, the System 600 may be implemented on computer(s) or a computer-based network. The Processor 610 may be a computer capable of data manipulation, data analysis and other functionality. For example, Processor 610 may include a Customer Behavior Examination Module 612, Segmentation Module 614, Strategic Marketing Plan Generator 616, as well as other functionality, as shown by Other Module 618. According to an embodiment of the present invention, the computer may be a standard computer comprising an input device, an output device, a processor device and a data storage device. Database 620, 622 may be a plurality of databases containing data records related to customer information. The User Interface 630 may be a graphical user interface for obtaining input from and presenting results to a user of the system. According to an embodiment of the present invention, the User Interface 630 may be a display, such as a CRT, LCD or touch-screen monitor, or a computer terminal, or a personal computer connected to Processor 610. According to another embodiment of the present invention, the system may include components of a software system. The system may operate on a network and may be connected to other systems sharing a common database. Other hardware arrangements may also be provided.

By way of example, operation of System 600 for generating a strategic marketing plan will now be described, according to one embodiment of the present invention. A user of the system may submit a request through the User Interface 630. The request may be for a strategic marketing plan or other inquiry. The user of the system may include a representative of an entity desiring to grow and enhance customer relations. For example, the entity may include a brokerage general agency or other entity providing services and/or products.

Processor 610 may receive an input (e.g., request) from the user. Customer behavior data may be obtained from one or more databases, as represented by database 620, 622, as well as other sources. Database 620, 622 may be associated with the entity and provide specific information related to the entity's customers. Customer Behavior Examination Module 612 may then examine customer behavior based on the data retrieved from database 620, 622 as well as other sources of information. Segmentation Module 614 may segment the customers into a plurality of segments based on the analyzed customer behavior data. Customer needs and values assessment information may be received at input 640, which may be analyzed through a qualitative phase and a quantitative phase. The information gathered may be entered at input 640, forwarded to Processor 610 and further processed by Processor 610. Finally, Strategic Marketing Plan Module 616 may then generate a strategic marketing plan for each segment. The strategic marketing plan may be presented to the user via User Interface 630.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. A method for implementing a strategic marketing plan for enhancing customer relations for an entity; the method comprising the steps of:
conducting behavior examination for one or more customers based on a recency factor, a frequency factor and a monetary factor;
segmenting the one or more customers into a segment set based on a score, wherein the score comprises a value associated with the recency factor, the frequency factor and the monetary factor;
assessing a customer need through a qualitative assessment and a quantitative assessment; and
generating a strategic marketing plan based on the steps of conducting, segmenting and assessing.

2. The method of claim 1, wherein the step of conducting further comprises the steps of:
determining a number of cells for each one of the recency factor, the frequency factor and the monetary factor;
providing a cell specification for each cell for each one of the recency factor, the frequency factor and the monetary factor; and
assigning each customer a recency score, a frequency score and a monetary score based on an appropriate cell specification.

3. The method of claim 1, wherein the segment set comprises a plurality of segments comprising at least a first segment, a second segment and a third segment.

4. The method of claim 3, wherein the first segment represents a set of most active customers.

5. The method of claim 3, wherein the second segment represents a set of moderately active customers.

6. The method of claim 3, wherein the third segment represents a set of at risk customers.

7. The method of claim 1, wherein the step of segmenting further comprises the steps of:
assigning each possible score to a segment; and
categorizing each customer to a segment based on the score associated with each customer.

8. The method of claim 1, wherein the qualitative assessment comprises gathering one or more of perception data, relationship data and selection data.

9. The method of claim 8, wherein the qualitative assessment comprises conducting one or more of focus groups and interviews.

10. The method of claim 1, wherein the quantitative assessment comprises one or more of performing needs verification, gathering demographic data, identifying communication preferences, and measuring satisfaction.

11. The method of claim 1, wherein the strategic marketing plan comprises at least one customer segment profile for each segment.

12. The method of claim 11, wherein the customer segment profile comprises one or more of demographic profile, market profile, needs profile and primary segment goal.

13. The method of claim 1, wherein the strategic marketing plan comprises at least one primary business goal.

14. The method of claim 1, wherein the strategic marketing plan comprises at least one customer segment strategy for each segment.

15. The method of claim 14, wherein the customer segment strategy comprises one or more of a primary segment goal, segment objective and tactic.

16. A system for implementing a strategic marketing plan for enhancing customer relations for an entity; the system comprising:
a customer behavior examination module for conducting behavior examination for one or more customers based on a recency factor, a frequency factor and a monetary factor;
a segmentation module for segmenting the one or more customers into a segment set based on a score, wherein the score comprises a value associated with the recency factor, the frequency factor and the monetary factor;
an assessment input for assessing a customer need through a qualitative assessment and a quantitative assessment; and
a strategic marketing plane module for generating a strategic marketing plan based on the steps of conducting, segmenting and assessing.

17. The system of claim 16, wherein the customer behavior module further determines a number of cells for each one of the recency factor, the frequency factor and the monetary factor; provides a cell specification for each cell for each one of the recency factor, the frequency factor and the monetary factor; and assigns each customer a recency score, a frequency score and a monetary score based on an appropriate cell specification.

18. The system of claim 16, wherein the segment set comprises a plurality of segments comprising at least a first segment, a second segment and a third segment.

19. The system of claim 18, wherein the first segment represents a set of most active customers.

20. The system of claim 18, wherein the second segment represents a set of moderately active customers.

21. The system of claim 18, wherein the third segment represents a set of at risk customers.

22. The system of claim 16, wherein the segmentation module further assigns each possible score to a segment; and categorizes each customer to a segment based on the score associated with each customer.

23. The system of claim 16, wherein the qualitative assessment comprises gathering one or more of perception data, relationship data and selection data.

24. The system of claim 23, wherein the qualitative assessment comprises conducting one or more of focus groups and interviews.

25. The system of claim 16, wherein the quantitative assessment comprises one or more of performing needs verification, gathering demographic data, identifying communication preferences, and measuring satisfaction.

26. The system of claim 16, wherein the strategic marketing plan comprises at least one customer segment profile for each segment.

27. The system of claim 26, wherein the customer segment profile comprises one or more of demographic profile, market profile, needs profile and primary segment goal.

28. The system of claim 16, wherein the strategic marketing plan comprises at least one primary business goal.

29. The system of claim 16, wherein the strategic marketing plan comprises at least one customer segment strategy for each segment.

30. The system of claim 29, wherein the customer segment strategy comprises one or more of a primary segment goal, segment objective and tactic.
